(19) United States
(12) Patent Application Publication
(10) Pub. No.: US 2007/0231614 A1
(43) Pub. Date: Oct. 4, 2007

(54) Ferrite material, ferrite film formed thereof, and radio frequency identification tag with ferrite film

(75) Inventors: Koichi Kondo, Sendai-shi (JP); Hiroshi Ono, Sendai-shi (JP); Shigeyoshi Yoshida, Sendai-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NEC TOKIN Corporation, Sendai-shi (JP)

(21) Appl. No.: 11/717,386

(22) Filed: Mar. 13, 2007

(30) Foreign Application Priority Data
Mar. 14, 2006 (JP) 2006-69378

(51) Int. Cl. G11B 5/708; G08B 13/14

(52) U.S. Cl. 428/842.1; 340/572.8; 340/572.6

(57) ABSTRACT

A ferrite material is disclosed, consisting of an oxide metal composition, the metal composition having the formula of FeₐNi_{b}Zn_{c}Co_{d}, where: a+b+c+d=3.0; 2.1≦a≦2.7; 0≦b≦0.4; 0≦c≦0.4; and 0.1≦d≦0.5. A ferrite film is made of the ferrite material. Preferably, the ferrite film is formed by a ferrite plating method to have a thickness of 30 μm or less and an aspect ratio of 30 or more. The ferrite film is arranged or provided in the vicinity of an antenna conductor of a radio frequency identification tag. The ferrite film may be in direct contact with the antenna conductor.

### BACKGROUND OF THE INVENTION

This invention relates to a ferrite material, a ferrite film made of the ferrite material and a radio frequency identification (RFID) tag with the ferrite film.

A general RFID system comprises a non-contact or contactless communication module or device such as an RFID tag or transponder and an interrogator or reader/writer communicating with the module or device and is recently used in a management system for tracking items or products.

As well known, communication properties of an RFID tag strongly depends on conditions where the RFID tag is used, for example, a material of an item to which the RFID tag is glued or attached. In particular, an RFID tag is positioned close to a metallic structure so that its communication properties are deteriorated.

In order to solve the above-mentioned deterioration problem, JP-A 2006-5836 discloses an approach to use a non-conductive magnetic sheet, preferably, a complex material sheet that comprises soft magnetic powder particles and an insulator binder agent binding the particles. The disclosure of JP-A 2006-5836 is incorporated herein by reference in its entirety.

However, the present inventors have found that such a complex material sheet cannot improve communication properties of an RFID tag if the RFID tag is used at a high carrier frequency band. For example, in Japan, a carrier frequency band for RFID system has a center frequency of 13.56 MHz, 900 MHz or 2.45 GHz. Among them, a complex material is not effective in a carrier frequency band of 900 MHz or 2.45 GHz. Therefore, there is a need for a novel magnetic material that can improve communication properties of an RFID tag even if the RFID tag is used at a high carrier frequency band whose center frequency is for example 900 MHz, 2.45 GHz or higher.

### SUMMARY OF THE INVENTION

In order to fulfill the above mentioned need, a magnetic material is required to have a complex permeability whose real part μ′ is larger but whose imaginary part μ″ is smaller at a target carrier frequency band; to this end, a natural resonance frequency fr of the magnetic material be higher than the target carrier frequency band. In general, a natural resonance frequency fr of a magnetic material is a frequency at which a real part permeability μ′ of the material is a half of the initial permeability μᵢ of the material.

As a result of studies, the present inventors have found that a specific NiZnCo ferrite meets the above requirements, as discussed by Yoshida et. al. in “Plated Ferrite Thin Films for RF Devices”, Digests of the 30th Annual Conference on Magnetics, 11pG-AF6, p 437-438, 2006, the disclosure of which is incorporated herein by reference in its entirety.

Based on the above studies, one aspect of the present invention provides a ferrite material that consists of an oxide metal composition whose metal composition has the formula of FeₐNi_{b}Zn_{c}Co_{d}, where: a+b+c+d=3.0; 2.1≦a≦2.7; 0≦b≦0.4; 0≦c≦0.4; and 0.1≦d≦0.5.

Another aspect of the present invention provides a ferrite film made of the ferrite material as mentioned above.

Another aspect of the present invention provides an RFID tag that comprises: a main member including an antenna conductor; and the ferrite film as mentioned above, wherein the ferrite film is in contact with the main member or is arranged in the vicinity of the main member.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing an RFID tag according to an embodiment of the present invention;

FIG. 2 is an exploded, perspective view showing the RFID tag of FIG. 1;

FIG. 3 is a view schematically showing a film formation apparatus that is used for forming a ferrite film shown in FIG. 2;

FIG. 4 is a top plan view schematically showing an arrangement for evaluating the RFID tag of FIG. 1, wherein a dipole antenna of a reader is now shown;

FIG. 5 is a side view schematically showing the arrangement of FIG. 4 that includes the dipole antenna, too;

FIG. 6 is a graph showing a result of evaluation in accordance with the arrangement of FIGS. 4 and 5;

FIG. 7 is a perspective view showing a modification of the foregoing RFID tag of FIG. 1; and

FIG. 8 is a perspective view showing another modification of the foregoing RFID tag of FIG. 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

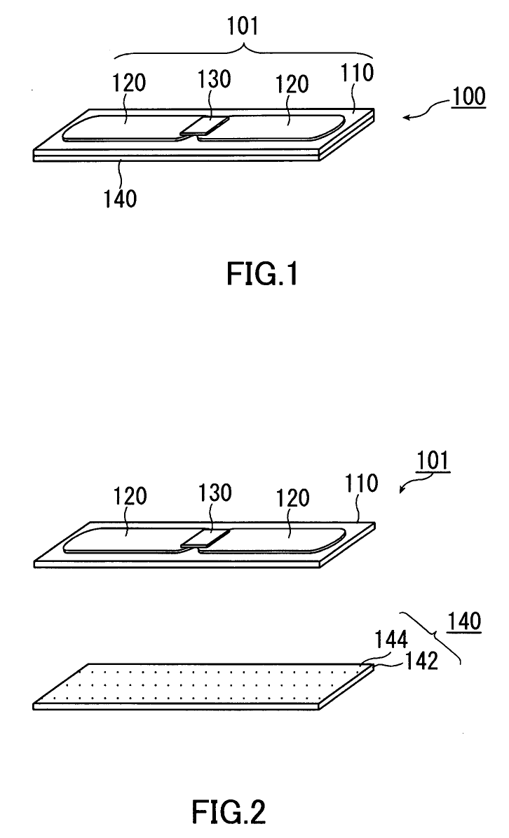

With reference to FIGS. 1 and 2, an RFID tag 100 according to an embodiment of the present invention comprises a main member 101 and a ferrite sheet 140 glued to the bottom surface of the main member 101. The illustrated main member 101 comprises a tag base 110. In this embodiment, the tag base 110 is made of polyethylene terephthalate (PET). On the top surface of the tag base 110, a plane antenna conductor 120 is formed by printing. On the center of the antenna conductor 120, an integrated circuit (IC) chip is mounted.

As best shown in FIG. 2, the illustrated ferrite sheet 140 comprises a supporter sheet 142 made of polyimide, on a surface of which a ferrite film 144 is directly formed by a ferrite plating method. The ferrite plating method is a method as disclosed in U.S. Pat. No. 4,477,319, the contents of which are incorporated herein by reference in their entireties. The ferrite plating method of the present embodiment comprises the steps of: preparing a specific solution containing at least ferrous ions; bringing a surface of a target into the specific solution to cause Fe²⁺ ions, or Fe²⁺ ions and other metal hydroxide ions, to be absorbed on the surface of the target; oxidizing the absorbed Fe²⁺ ions to obtain Fe³⁺ ions to cause the Fe3+ ions and metal hydroxide ions in the specific solution to undergo a ferrite crystallization reaction so that a ferrite film is formed on the surface of the target. The target of the ferrite plating according to the present embodiment is the supporter sheet 142.

In this embodiment, the thus obtained ferrite sheet 140 is glued to the main member 101 such that the ferrite film 144 is brought into contact with the bottom surface of the tag base 110. The ferrite film 144 of the present embodiment has an area size same as the bottom area size of the main member 101, i.e. the bottom area size of the tag base 110. The ferrite film 144 may be formed by another method such as a spatter method. In addition, the ferrite sheet 140 may be formed by sintering the following ferrite material as such.

The ferrite film 144 of the present embodiment is made of a ferrite material consisting of an oxide metal composition, the metal composition having the formula of FeₐNi_{b}Zn_{c}Co_{d}, where: a+b+c+d=3.0; 2.1≦a≦2.7; 0≦b≦0.4; 0≦c≦0.4; and 0.1≦d≦0.5. In general, amount of oxygen follows the formula of ferrite composition, M₃O₄, where M is metal composition. However, the present invention is not strictly limited thereto but allows surplus or deficiency of oxygen.

In consideration of the art of RFID tag, i.e. a device with antenna, it is preferable that the ferrite film 144 has a higher real part μ′ of permeability. The ferrite film 144 preferably has a relatively thicker thickness t, but even the thickness t of 3 μm can contribute to a good result. Note here that, if the thickness t of the ferrite film 144 is larger than 30 μm, its magnetic resonance becomes similar to that of a ferrite bulk so that its natural resonance frequency fr becomes relatively lower. Therefore, in consideration of the art of RFID tag, it is preferable that the ferrite film 144 has a thickness not larger than 30 μm. Furthermore, it is preferable that the ferrite film 144 has an aspect ratio not smaller than 30. In this embodiment, the ferrite film 144 has a rectangular shape defined by lateral sides and longitudinal sides. In this case, the aspect ratio is represented as l/t, where l is the length of the lateral side of the ferrite film, and t is the thickness of the ferrite film. In addition, if the ferrite film has a tan δ(=μ″/μ′) larger than 1.0, its loss property is too large to be used for an antenna device such as an RFID tag. Therefore, in consideration of the art of RFID tag, it is preferable that the ferrite film has a tan δ(=μ″/μ′) of 1.0 or less at 900 MHz. It is also preferable that the ferrite film has a resistivity of 0.1 Ωcm or more because lower resistivity deteriorates antenna properties of an RFID tag.

For evaluation of properties of ferrite films, various kinds of ferrites films were formed as shown in the following table, wherein Examples 1˜15 have the respective compositions belonging to the formula according to this embodiment, while compositions of Comparative Examples 1˜3 do not belong to.

| | Solution | | | | Film | | | | | | μ′ | μ″ | μ″/μ′ | |
|---|---|---|---|---|---|---|---|---|---|---|---|---|---|---|
| | Composition(mol %) | | | | Composition(mol %) | | | | t | ρ | at | at | at | fr |
| | Fe | Ni | Zn | Co | Fe | Ni | Zn | Co | (μm) | (Ωcm) | 900 MHz | 900 MHz | 900 MHz | (MHz) |
| Example 1 | 64.9 | 19.6 | 0.7 | 14.9 | 2.2 | 0.3 | 0.3 | 0.2 | 1.0 | 5.E+05 | 7 | 1.6 | 0.2 | 3000 |
| Example 2 | 64.2 | 20.1 | 0.7 | 14.9 | 2.2 | 0.2 | 0.3 | 0.3 | 0.5 | 2.E+06 | 6 | 1.5 | 0.3 | 3000 |
| Example 3 | 64.7 | 19.7 | 0.7 | 14.9 | 2.1 | 0.2 | 0.4 | 0.3 | 1.4 | 3.E+06 | 7 | 3 | 0.4 | 2000 |
| Example 4 | 65.6 | 19.6 | 0.0 | 14.7 | 2.5 | 0.2 | 0.0 | 0.3 | 1.3 | 3.E+04 | 8 | 0.8 | 0.1 | 5500 |
| Example 5 | 64.2 | 20.1 | 0.4 | 15.3 | 2.3 | 0.2 | 0.2 | 0.3 | 1.4 | 9.E+04 | 6 | 1 | 0.2 | 4800 |
| Example 6 | 65.2 | 20.5 | 0.7 | 13.6 | 2.2 | 0.2 | 0.3 | 0.3 | 0.8 | 1.E+05 | 7 | 1.5 | 0.2 | 3000 |
| Example 7 | 64.0 | 20.1 | 0.7 | 15.2 | 2.2 | 0.2 | 0.3 | 0.3 | 2.0 | 1.E+05 | 6 | 0.8 | 0.1 | 6300 |
| Example 8 | 63.5 | 18.7 | 0.6 | 17.2 | 2.4 | 0.0 | 0.2 | 0.4 | 12.0 | 8.E+02 | 5 | 0.8 | 0.2 | 6000 |
| Example 9 | 78.0 | 0.0 | 0.0 | 22.0 | 2.6 | 0.0 | 0.0 | 0.4 | 2.0 | 3.E+02 | 3 | 0.1 | 0.03 | 7500 |
| Example 10 | 72.9 | 22.1 | 0.7 | 4.2 | 2.5 | 0.2 | 0.2 | 0.1 | 0.5 | 4.E+04 | 20 | 18 | 1.0 | 1200 |
| Example 11 | 69.7 | 10.6 | 0.3 | 19.4 | 2.4 | 0.1 | 0.1 | 0.4 | 2.7 | 2.E+03 | 4 | 0.02 | 0.01 | 7100 |
| Example 12 | 81.9 | 0.0 | 0.0 | 18.1 | 2.7 | 0.0 | 0.0 | 0.3 | 5.0 | 1.E−01 | 5 | 0.08 | 0.02 | 6900 |
| Example 13 | 67.5 | 0.0 | 0.0 | 32.5 | 2.5 | 0.0 | 0.0 | 0.5 | 2.7 | 9.E+02 | 2 | 0.01 | 0.01 | 9900 |
| Example 14 | 59.9 | 25.0 | 0.0 | 15.0 | 2.3 | 0.4 | 0.0 | 0.3 | 1.5 | 6.E+03 | 6 | 0.8 | 0.13 | 5800 |
| Example 15 | 73.2 | 22.3 | 0.8 | 3.7 | 2.6 | 0.1 | 0.2 | 0.1 | 1.0 | 3.E+02 | 23 | 20 | 1.0 | 1000 |
| Comparative | 86.0 | 0.0 | 0.0 | 14.0 | 2.8 | 0.0 | 0.0 | 0.2 | 4.2 | 3.E−02 | 6 | 0.6 | 0.1 | 3500 |
| Example 1 | | | | | | | | | | | | | | |
| Comparative | 75.3 | 23.9 | 0.8 | 0.0 | 2.6 | 0.2 | 0.2 | 0.0 | 0.5 | 2.E+03 | 45 | 40 | 0.5 | 500 |
| Example 2 | | | | | | | | | | | | | | |
| Comparative | 71.1 | 22.5 | 2.3 | 4.1 | 2.2 | 0.2 | 0.5 | 0.1 | 0.5 | 5.E+05 | 18 | 18 | 0.6 | 500 |
| Example 3 | | | | | | | | | | | | | | |

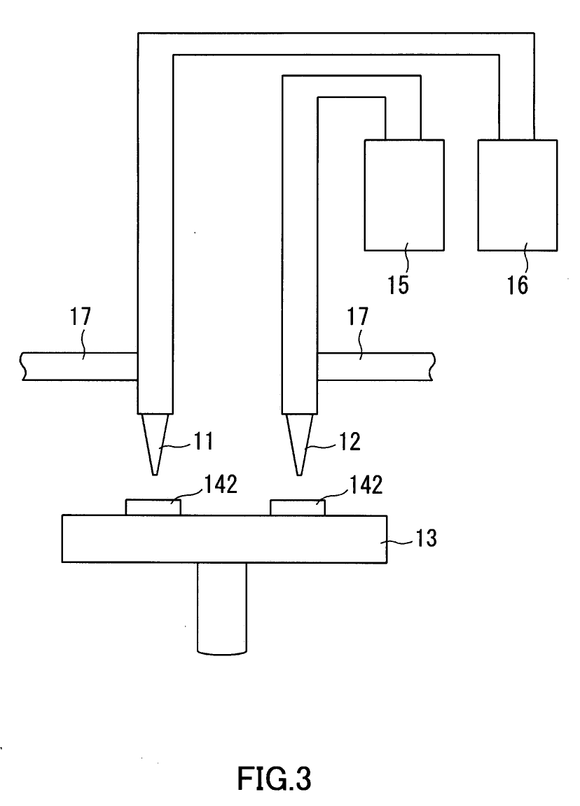

The ferrite films were formed by using a film formation apparatus as schematically shown in FIG. 3. The illustrated film formation apparatus comprises nozzles 11, 12, a turn table 13, tanks 15, 16 and gas inlets 17. The tanks 15, 16 contain the solutions for ferrite plating and other solutions for oxidization; the solutions for ferrite plating have the respective compositions as shown in the above table. The gas inlets 17 are used to introduce nitrogen gas into nozzles.

In order to form a ferrite film by the use of the apparatus of FIG. 3, targets such as the supporter sheets 142 in this embodiment were put onto the turn table 13, and the solutions were provided from the tanks 15, 16 onto the supporter sheets 142 through the nozzles 11, 12 together with the nitrogen gas introduced from the gas inlets 17. Upon the provision of the solutions, first and second steps were repeatedly performed in turn so as to obtain the ferrite sheets 140, i.e. the supporter sheets 142 with the ferrite films 144, wherein the first step is of providing the solution onto one of the supporter sheets 142 through the nozzle 11, followed by removing excess liquid of the solution by using a centrifugal force of the turn table 13; likewise, the second step is of providing the solution onto the supporter sheet 142 through the nozzle 12, followed by removing excess liquid of the solution by using a centrifugal force of the turn table 13.

More in detail, polyimide sheets were prepared as the supporter sheets 142 and were mounted on the turn table 13, each polyimide sheet having a thickness of 25 μm. The turn table 13 was turned at 150 rpm while deoxidized ion-exchange water was provided on the polyimide sheets under a heat condition up to 90° C. Next, nitrogen gas was introduced into the film formation apparatus so that deoxide atmosphere was created in the apparatus. Each solution for ferrite plating (reaction solution) was formed by dissolving FeCl₂-4H₂O, NiCl₂-6H₂O, ZnCl₂, CoCl₂-6H₂O into deoxidized ion-exchange water in accordance with a molar ratio shown in the above table. On the other hand, an oxidizing solution is formed by dissolving NaNO₂ and CH₃COONH₄ into deoxidized ion-exchange water. The reaction solution and the oxidizing solution were provided onto the polyimide sheets through the nozzles 11, 12, wherein each of their flow rates is about 40 ml/min. As a result of the above processes, black ferrite films 144 were formed on the surfaces of the supporter sheets 142, respectively.

Furthermore, analyses were carried out on the thus obtained ferrite films. Specifically, a scanning electron microscope (SEM) was used for a configuration analysis. As the result, it was verified that each ferrite film has a uniform thickness. Chemical composition of each film was examined by cutting each film into a piece of 3 cm²˜5 cm², followed by dissolving the piece into a hydrochloric acid solution to analyze the obtained solution by an inductively coupled plasma spectroscopy (ICPS) method. Permeability of each film was measured by the use of a permeability measurer based on a shielded loop coil method. The results of analyses are shown in the foregoing table.

As apparent from the contents of the table, each of the plated ferrite films of Examples 1˜15 had a natural resonance frequency fr of 1 GHz or more and a resistivity of 0.1 Ωcm or more. On the other hand, each of the plated ferrite films of Comparative Examples 1˜3 had a lower natural resonance frequency fr or a smaller resistivity.

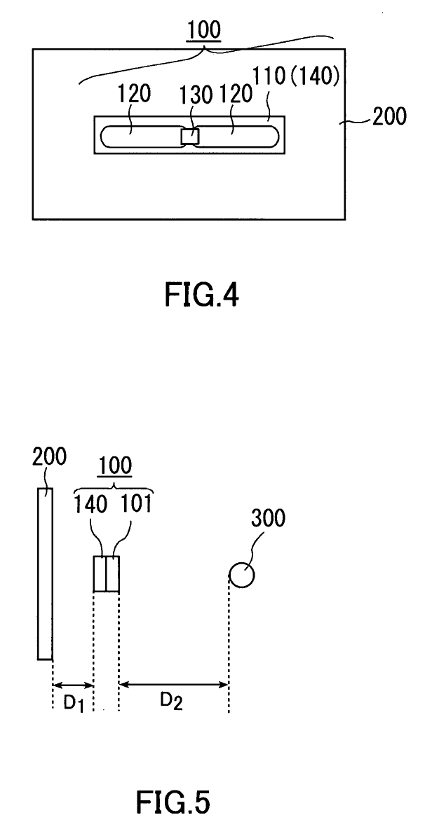

Effect of provision of ferrite film 144 for RFID 100 tag was evaluated, where the type of the evaluated ferrite film 144 was of Example 1. The evaluated RFID tags 100 were for 900 MHz frequency band and each had the antenna conductor 120 that had a length of about 10 cm and a width of about 2 cm. One of the evaluated RFID tags 100 was provided with a single sheet of the ferrite sheet 140. Another evaluated RFID tag was provided with three ferrite sheets 140 stacked. As a comparative one, a conventional RFID tag with no ferrite film was also prepared. The evaluations were carried out within an electric wave anechoic chamber in accordance with an arrangement shown in FIGS. 4 and 5. The evaluation conditions are as follows:

RFID Reader Module: MP9311, a product of SAMSys Technologies, Inc.;

Communication Antenna of Reader: dipole type, fixed in horizontal;

RFID Tag: dipole antenna of about 10 cm×2 cm, fixed in horizontal;

Metal Plate: 25 cm×10 cm;

Arrangement:
RFID tag is positioned in front of communication antenna of reader;

Polarization: horizontal polarization; and

Power: 50 mW.

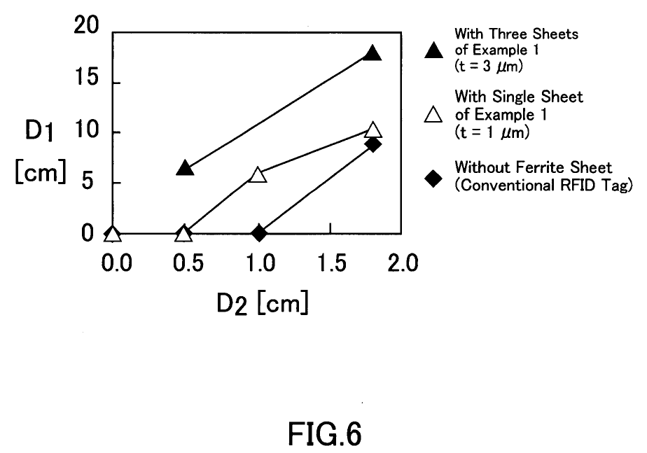

The evaluations were directed to the relation between a distance D₁ and a maximum detectable distance D₂, wherein the distance D₁ is a distance between the metal plate 200 and the evaluated RFID tag 100, while the maximum detectable distance D₂ is a distance between the communication antenna 300 of the reader and the RFID tag 100 and enables the reader to detect the RFID tag. The result relation is shown in FIG. 6. As apparent from FIG. 6, the ferrite film 144 of the present example improved the communication ability of the evaluated RFID tag 100 even if the RFID tag was positioned near to the metal plate.

Although the present invention is explained with the above-mentioned concrete embodiment, the present invention is not limited thereto. Modifications are allowed, providing that the ferrite film belonging to the above mentioned formula be in contact with the antenna conductor 120 or be arranged in the vicinity of the antenna conductor 120.

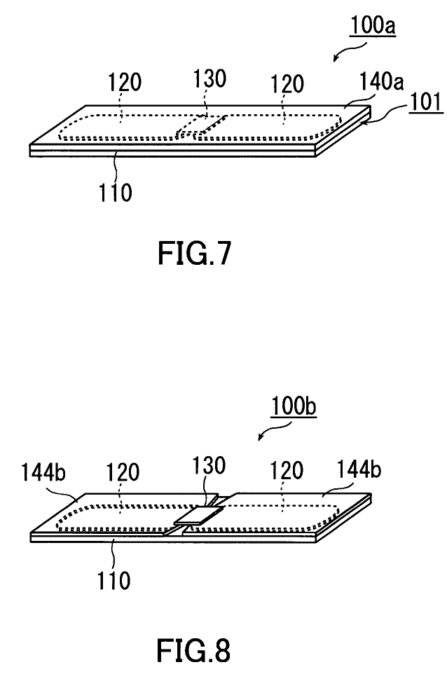

With reference to FIG. 7, a suitable modification 100a is formed by gluing a ferrite sheet 140a to the main member 101 such that its ferrite film is in contact with the antenna conductor 120. The ferrite sheets 140, 140a may be disposed upside down in the embodiments of FIGS. 1 and 7, respectively.

With reference to FIG. 8, another modification 100b is manufactured by forming a ferrite film 144b directly on the antenna conductor 120 without using the explained supporter sheet 142. In this modification, the ferrite film formation process is performed after a masking process for the IC chip 130 to protect the IC chip 130 from the ferrite film formation process. A ferrite film may be formed directly on the bottom surface of the main member 101. In addition, if the antenna conductor 120 be made of a hard material, the tag base 110 may be omitted.

The present application is based on Japanese patent applications of JP2006-069378 filed before the Japan Patent Office on Mar. 14, 2006, the contents of which are incorporated herein by reference.

While there has been described what is believed to be the preferred embodiment of the invention, those skilled in the art will recognize that other and further modifications may be made thereto without departing from the sprit of the invention, and it is intended to claim all such embodiments that fall within the true scope of the invention.

1. A ferrite material consisting of an oxide metal composition, the metal composition having the formula of FeₐNiₐZn_{b}Co_{d}, where:
a+b+c+d=3.0;
2.1≦a≦2.7;
0≦b≦0.4;
0≦c≦0.4; and
0.1≦d≦0.5.

2. The ferrite material according to claim 1, having a natural resonance frequency of 1 GHz or more.

3. The ferrite material according to claim 1 or 2, having a tan δ(=μ″/μ′) of 1.0 or less at 900 MHz.

4. The ferrite material according to claim 3, having a resistivity of 0.1 Ωcm or more.

5. A ferrite film made of the ferrite material according to claim 1.

6. The ferrite film according to claim 5, formed by a ferrite plating method.

7. The ferrite film according to claim 5 or 6, having a thickness of 30 μm or less.

8. The ferrite film according to claim 7, having an aspect ratio of 30 or more.

9. A radio frequency identification (RFID) tag, comprising:
a main member including an antenna conductor; and
the ferrite film according to claim 5 or 6, the ferrite film being in contact with the main member or being arranged in the vicinity of the main member.

10. The RFID tag according to claim 9, wherein the main member further comprising a tag base, the tag base having a top surface, the antenna conductor being provided on the top surface of the tag base.

11. The RFID tag according to claim 10, wherein the tag base has a bottom surface, and the ferrite film is in contact with the bottom surface of the tag base.

12. The RFID tag according to claim 9, wherein the ferrite film is in direct contact with the antenna conductor.

13. The RFID tag according to claim 9, further comprising a supporter, the ferrite film being formed on the supporter.

14. The ferrite material according to claim 1 or 2, having a resistivity of 0.1 Ωcm or more.

15. A ferrite film made of the ferrite material according to claim 2.

16. The ferrite film according to claim 15, formed by a ferrite plating method.
